(19) United States
(12) Patent Application Publication
(10) Pub. No.: US 2006/0282846 A1
(43) Pub. Date: Dec. 14, 2006

(54) CARTRIDGE CASE AND INFORMATION MEDIUM

(75) Inventors: Hiroshi KANEDA, Tokyo (JP); Masaru IKEBE, Tokyo (JP); Kenji HASHIZUME, Tokyo (JP); Akio MOMOI, Tokyo (JP); Susumu YANAGIHARA, Tokyo (JP)

Correspondence Address: GREENBLUM & BERNSTEIN, P.L.C., 1950 ROLAND CLARKE PLACE, RESTON, VA, 20191, US

(73) Assignee: TDK CORPORATION, Tokyo (JP)

(21) Appl. No.: 11/422,155

(22) Filed: Jun. 5, 2006

(30) Foreign Application Priority Data
Jun. 8, 2005 (JP) 2005-167654

(51) Int. Cl. G11B 23/03

(52) U.S. Cl. 720/728

(57) ABSTRACT

A cartridge case includes: a case main body that has a partition wall, which constructs an enclosure for enclosing a disc-shaped medium, erected on a top surface thereof; an inner rotor that has a main portion and a side wall erected along an outer circumferential edge of the main portion and is rotatably disposed inside the case main body in a state where the side wall is fitted onto an outside of the partition wall; and a shutter that is disposed between the inner rotor and the case main body and moves as the inner rotor rotates, to open and close an access path for accessing the disc-shaped medium. The inner rotor includes bar-shaped protrusions formed on an inner circumferential surface of the side wall in a direction in which the side wall is erected.

### BACKGROUND OF THE INVENTION

1. Field of the Invention

The present invention relates to a cartridge case including a case main body in which a disc-shaped medium is enclosed and a shutter that opens and closes an access opening formed in the case main body, and to an information medium where a disc-shaped medium is enclosed inside the cartridge case.

2. Description of the Related Art

As one example of this type of information medium, a disc recording medium apparatus disclosed by Japanese Laid-Open Patent Publication No. 2003-115181 is known. This disc recording medium apparatus includes a cartridge case including an upper shell, a middle shell (inner rotor), and a lower shell, an optical disc enclosed within a disc enclosure inside the cartridge case, and a shutter member that is disposed between the middle shell and the lower shell and opens and closes openings formed in the middle shell and the lower shell. An arc-shaped cam groove is formed in an outer circumferential portion of the upper shell. The middle shell includes a ring portion including an arc-shaped cam portion capable of fitting into the cam groove of the upper shell. When this disc recording medium apparatus is inserted into a disc drive apparatus, the middle shell is rotated by the disc drive apparatus and the shutter member is caused to rotate by the rotation of the middle shell, thereby opening and closing the openings in the middle shell and the lower shell.

### SUMMARY OF THE INVENTION

However, by investigating the conventional disc recording medium apparatus described above, the present inventors discovered the following problem That is, with the disc recording medium apparatus described above, the openings of the middle shell and the lower shell are opened and closed by rotation of the shutter member that accompanies rotation of the middle shell. To prevent damage to the optical disc, the middle shell is composed of a flexible resin material and is formed with a smooth surface. This means that there is a problem in that when the middle shell is rotated, there is the risk of the sliding parts of the upper shell and the middle shell (in this case, the cam groove of the upper shell and the cam portion of the middle shell) tightly contacting one another, thereby making rotation of the middle shell difficult. To avoid tight contact between such members, a method such as subjecting an inner circumferential surface of the cam portion (ring portion) of the middle shell to a texturing process and forming a convex/concave portion could be used. However, when such method is used, if the middle shell is manufactured by injection molding, it becomes difficult to release the middle shell from the mold, resulting in the problem of low manufacturing efficiency. This makes adoption of such method problematic.

The present invention was conceived in view of the problem described above and it is a principal object of the present invention to provide a cartridge case and an information medium that enable an inner rotor to rotate smoothly and have high manufacturing efficiency.

To achieve the stated object, a cartridge case according to the present invention includes: a case main body that has a partition wall, which is circular or arc-shaped in planar form and constructs an enclosure for rotatably enclosing a disc-shaped medium, erected on a top surface thereof and a first opening formed in a bottom surface thereof; an inner rotor that has a circular-plate-shaped main portion in which a second opening is formed and a side wall erected along an outer circumferential edge of the main portion and is rotatably disposed inside the case main body in a state where the side wall is fitted onto an outside of the partition wall; and a shutter that is disposed between the inner rotor and the bottom surface and moves as the inner rotor rotates, to open and close an access path for accessing the disc-shaped medium via the first and second openings, wherein the inner rotor includes bar-shaped protrusions formed on an inner circumferential surface of the side wall along a direction in which the side wall is erected.

An information medium according to the present invention includes the cartridge case described above and the disc-shaped medium enclosed inside the case main body of the cartridge case.

According to the cartridge case and information medium described above, by constructing the inner rotor so as to include bar-shaped protrusions formed on an inner circumferential surface of the side wall along a direction in which the side wall is erected, it is possible to have front ends of the protrusions on the inner rotor make line contact with the outer circumferential surface of the partition wall of the case main body. Since surface contact between the inner circumferential surface of the side wall and the outer circumferential surface of the partition wall is reliably avoided, the inner rotor can rotate smoothly and as a result, the access path can be opened and closed smoothly by movement (rotation) of the shutter. Also, by forming the protrusions in bar shapes along the direction in which the side wall is erected, during injection molding of the inner rotor, it is possible to reliably avoid a situation where the protrusions cause resistance and make it difficult to release the inner rotor from the mold. This means that unlike the conventional construction where the formation or a textured surface, for example, on the side wall makes it difficult to release the inner rotor from a mold, it is possible to manufacture the inner rotor and in turn the cartridge case and the information medium with sufficient efficiency without causing a decrease in manufacturing efficiency due to difficulty in releasing the inner rotor from the mold.

Another cartridge case according to the present invention includes: a case main body that has a partition wall, which is circular or arc-shaped in planar form and constructs an enclosure for rotatably enclosing a disc-shaped medium, erected on a top surface thereof and a first opening formed in a bottom surface thereof; an inner rotor that has a circular-plate-shaped main portion in which a second opening is formed and a side wall erected along an outer circumferential edge of the main portion and is rotatably disposed inside the case main body in a state where the side wall is fitted onto an outside of the partition wall; and a shutter that is disposed between the inner rotor and the bottom surface and moves as the inner rotor rotates, to open and close an access path for accessing the disc-shaped medium via the first and second openings, wherein the inner rotor has protrusions formed on a front end surface of the side wall.

Another information medium according to the present invention includes the cartridge case described above and the disc-shaped medium enclosed inside the case main body of the cartridge case.

According to the cartridge case and information medium described above, by forming protrusions on a front end surface of the side wall of the inner rotor, by forming the diameter of the side wall of the inner rotor slightly larger than the diameter of the partition wall of the case main body so that the inner rotor can be fitted onto the outside of the partition wall with some degree of play, for example, surface contact between the inner circumferential surface of the side wall and the outer circumferential surface of the partition wall can be reliably avoided and the front ends of the protrusions can make point contact with the top surface of the case main body. Accordingly, the inner rotor can rotate smoothly, and therefore the access route can be opened and closed smoothly by movement of the shutter. Also, by forming the protrusions on the front end surface of the side wall, during injection molding of the inner rotor, it is possible to reliably avoid a situation where the protrusions cause resistance when the inner rotor is released from the mold and make it difficult to release the inner rotor. As a result, it is possible to manufacture the inner rotor and in turn the cartridge case and the information medium with sufficient efficiency without causing a decrease in manufacturing efficiency due to difficulty in releasing the inner rotor from the mold.

Another cartridge case according to the present invention includes: a case main body that has a partition wall, which is circular or arc-shaped in planar form and constructs an enclosure for rotatably enclosing a disc-shaped medium, erected on a top surface thereof and a first opening formed in a bottom surface thereof; an inner rotor that has a circular-plate-shaped main portion in which a second opening is formed and a side wall erected along an outer circumferential edge of the main portion and is rotatably disposed inside the case main body in a state where the side wall is fitted onto an outside of the partition wall; and a shutter that is disposed between the inner rotor and the bottom surface and moves as the inner rotor rotates, to open and close an access path for accessing the disc-shaped medium via the first and second openings, wherein the case main body includes bar-shaped protrusions formed on an outer circumferential surface of the partition wall along a direction in which the partition wall is erected.

Another information medium according to the present invention includes the cartridge case described above and the disc-shaped medium enclosed inside the case main body of the cartridge case.

According to the cartridge case and information medium described above, by constructing the case main body so as to include bar-shaped protrusions formed on an outer circumferential surface of the partition wall along a direction in which the partition wall is erected, it is possible to have front ends of the protrusions on the case main body make line contact with the inner circumferential surface of the side wall of the inner rotor. This means that surface contact between the inner circumferential surface of the side wall and the outer circumferential surface of the partition wall can be reliably avoided and the inner rotor can rotate smoothly, and as a result the access path can be opened and closed smoothly by movement of the shutter. Also, by forming the protrusions in bar shapes along the direction in which the partition wall is erected, during injection molding of the case main body, it is possible to reliably avoid a situation where the protrusions cause resistance and make it difficult to release the case main body from the mold. Accordingly, it is possible to manufacture the case main body and in turn a cartridge case and an information medium with sufficient efficiency without causing a decrease in manufacturing efficiency due to difficulty in releasing the inner rotor from the mold.

Another cartridge case according to the present invention includes: a case main body that has a partition wall, which is circular or arc-shaped in planar form and constructs an enclosure for rotatably enclosing a disc-shaped medium, erected on a top surface thereof and a first opening formed in a bottom surface thereof; an inner rotor that has a circular-plate-shaped main portion in which a second opening is formed and a side wall erected along an outer circumferential edge of the main portion and is rotatably disposed inside the case main body in a state where the side wall is fitted onto an outside of the partition wall; and a shutter that is disposed between the inner rotor and the bottom surface and moves as the inner rotor rotates, to open and close an access path for accessing the disc-shaped medium via the first and second openings, wherein the case main body has protrusions formed at positions on the top surface that face a front end surface of the side wall.

Another information medium according to the present invention includes the cartridge case described above and the disc-shaped medium enclosed inside the case main body of the cartridge case.

According to the cartridge case and information medium described above, by constructing the case main body so as to have protrusions formed at positions on the top surface that face the front end surface of the side wall, by forming the diameter of the side wall of the inner rotor slightly larger than the diameter of the partition wall of the case main body so that the inner rotor can be fitted onto the outside of the partition wall with some degree of play, for example, surface contact between the inner circumferential surface of the side wall and the outer circumferential surface of the partition wall can be reliably avoided, and the front ends of the protrusions can make point contact with the front end surface of the side wall. Accordingly, the inner rotor can rotate smoothly, and as a result the access path can be opened and closed smoothly by movement of the shutter. Also, by forming the protrusions on the top surface, during injection molding of the case main body, it is possible to reliably avoid a situation where the protrusions cause resistance when the case main body is released from the mold and make it difficult to release the case main body. As a result, it is possible to manufacture the case main body and in turn the cartridge case and the information medium with sufficient efficiency without causing a decrease in manufacturing efficiency due to difficulty in releasing the case main body from the mold.

It should be noted that the disclosure of the present invention relates to a content of Japanese Patent Application 2005-167654 that was filed on 8 Jun. 2005 and the entire content of which is herein incorporated by reference.

### BRIEF DESCRIPTION OF THE DRAWINGS

These and other objects and features of the present invention will be explained in more detail below with reference to the attached drawings, wherein:

FIG. 1 is an external perspective view of a disc cartridge;

FIG. 2 is a cross-sectional view taken along a line C-C in FIG. 1;

FIG. 3 is a plan view of a lower shell when looking from an inner surface side thereof;

FIG. 4 is a plan view of an upper shell when looking from an inner surface side thereof;

FIG. 5 is a plan view of an inner rotor when looking from an upper shell side thereof;

FIG. 6 is a plan view of the periphery of a protrusion on the inner rotor;

FIG. 7 is a cross-sectional view taken along a line D-D in FIG. 6;

FIG. 8 is a cross-sectional view of the periphery of a protrusion in a disc cartridge;

FIG. 9 is a plan view of a shutter when looking from a lower shell side thereof;

FIG. 10 is a cross-sectional view of the periphery of a protrusion in another disc cartridge;

FIG. 11 is a cross-sectional view of the periphery of a protrusion in yet another disc cartridge;

FIG. 12 is a cross-sectional view of the periphery of a protrusion in yet another disc cartridge;

FIG. 13 is a cross-sectional view of the periphery of a protrusion in yet another disc cartridge; and

FIG. 14 is a cross-sectional view of the periphery of a protrusion in yet another disc cartridge.

### DESCRIPTION OF THE PREFERRED EMBODIMENTS

Preferred embodiments of a disc cartridge and an information medium according to the present invention will now be described with reference to the attached drawings.

First, the construction of a disc cartridge 1 will be described with reference to the drawings.

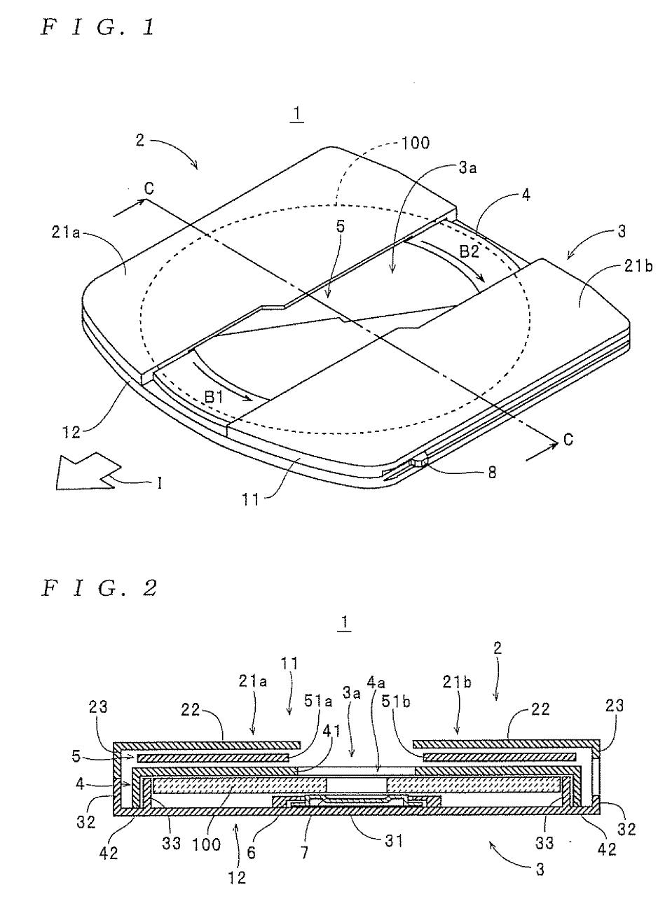

The disc cartridge 1 shown in FIGS. 1 and 2 is a cartridge-type information medium constructed so that various types of data can be recorded and reproduced and includes a cartridge case 2 and an optical disc 100. It should be noted that in FIG. 2, sizes in the thickness direction have been exaggerated for ease of understanding the present invention. The optical disc 100 corresponds to a “disc-shaped medium” for the present invention, is a single-sided rewritable disc-shaped recording medium, and is rotatably enclosed inside the cartridge case 2. On the other hand, the cartridge case 2 is one example of a “cartridge case” for the present invention and as shown in FIGS. 1 and 2, includes a case main body 3, an inner rotor 4, and a shutter 5.

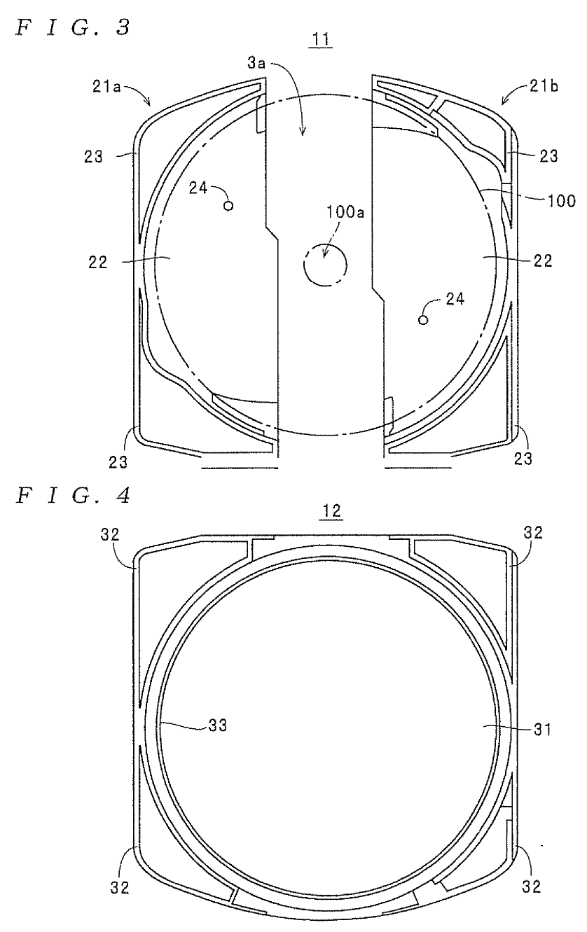

As shown in FIGS. 1 and 2, the case main body 3 includes a lower shell 11 and an upper shell 12 that can fit together. Note that for ease of understanding the present invention, in both drawings the case main body 3 is shown with the lower shell 11 facing upward. As shown in FIG. 3, the lower shell 11 includes a pair of lower shell main bodies 21a, 21b. The lower shell main bodies 21a, 21b each include a base plate 22 that constructs a base surface of the case main body 3 and a side wall 23 that is erected on an outer edge of the base plate 22 and constructs a side surface of the case main body 3. As shown in FIG. 1, the lower shell main bodies 21a, 21b are constructed so that in a state where the lower shell main bodies 21a, 21b have been fitted together with the upper shell 12 (i.e., where the lower shell main bodies 21a, 21b have been integrated with the upper shell 12), a disc-access opening 3a (corresponding to a “first opening” for the present invention) is formed between the respective base plates 22 of the lower shell main bodies 21a, 21b. The size and position of the opening 3a are set so that disc access by a drive apparatus (i.e., clamping by the drive apparatus, irradiation with a laser beam using an optical head, and the like) is possible for the optical disc 100 inside the cartridge main body 3 during the recording and reproducing of data. Also, as shown in FIG. 3, convex portions 24 that are inserted into slits 53 (see FIG. 9) of the shutter 5 and, as described later, cause the shutter 5 to slide as the inner rotor 4 rotates are erected on the respective base plates 22 of the lower shell main bodies 21a, 21b.

As shown in FIG. 4, the upper shell 12 includes a top plate 31 that constructs a top surface of the case main body 3, side walls that are erected at outer edges of the top plate 31 and together with the side walls 23 of the lower shell 11 construct the side surface parts of the case main body 3, and a partition wall 33 with a circular planar form that is erected in a central portion of the top plate 31 and forms an enclosure with a circular planar form for rotatably enclosing the optical disc 100 inside the case main body 3. Here, in place of the partition wall 33, it is possible to use a construction where a plurality of partition walls with arc-shaped planar forms are erected on a circle. Also, as shown in FIG. 2, a chucking plate 7 is attached to a central portion of the top plate 31 of the upper shell 12 by a ring-shaped attaching member 6. The chucking plate 7 is attached so as to be rotatable with respect to the upper shell 12 and slightly movable in a direction toward and away from the top plate 31.

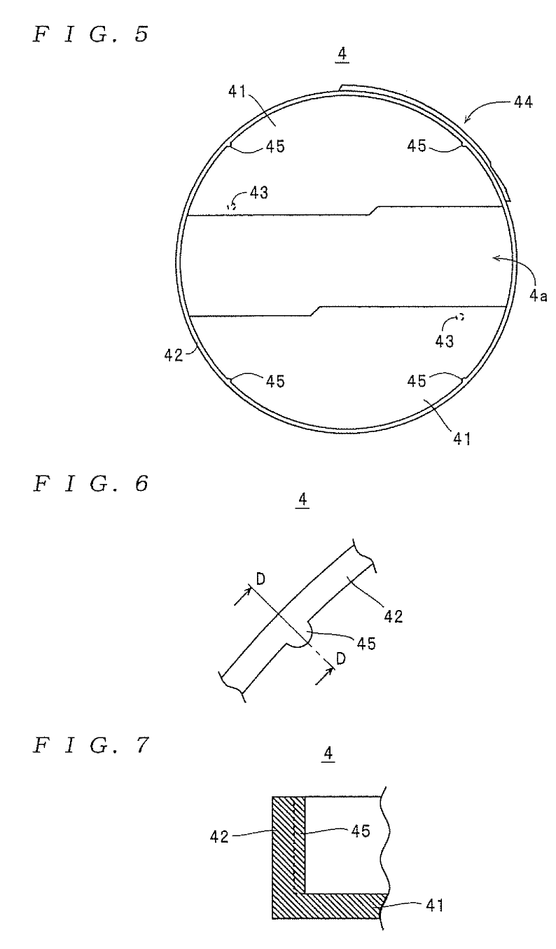

As shown in FIG. 5, the inner rotor 4 includes a circular-plate-shaped base plate 41 (which corresponds to a “main portion” for the present invention) in which an opening 4a is formed and a side wall 42 that is erected at an outer circumferential edge of the base plate 41, and is constructed as a shallow plate on which the optical disc 100 can be mounted. Here, the opening 4a corresponds to a “second opening” for the present invention, and is formed with substantially the same shape as the opening 3a of the lower shell 11 so that a drive apparatus can access the optical disc 100 inside the case main body 3 during the recording and reproducing of data. Also, convex portions 43 for axially supporting the shutter 5 are erected on the lower surface (an inner surface in the plane of the paper in FIG. 5) of the base plate 41. Engaging teeth 44 that can engage a shutter opening/closing means (not shown) of a drive apparatus are formed on the side wall 42. It should be noted that the respective teeth in the engaging teeth 44 have been omitted from FIG. 5.

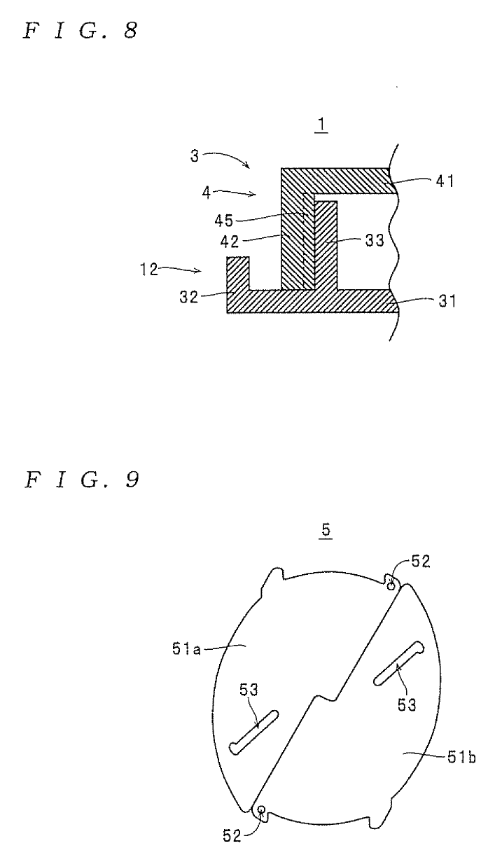

In addition, as shown in FIGS. 5 to 7, bar-shaped protrusions 45 that are semicircular in cross section are formed in the inner circumferential surface of the side wall 42 along the direction in which the side wall 42 is erected (the up-down direction in FIG. 7). The protruding length of the protrusions 45 from the inner circumferential surface of the side wall 42 to the front ends of the protrusions 45 is set equal to or slightly shorter than a difference between the radius of the inner circumferential surface of the side wall 42 and the radius of the outer circumferential surface of the partition wall 33 of the upper shell 12. In addition, as shown in FIG. 2, the inner rotor 4 is rotatably enclosed (disposed) inside the case main body 3 in a state where the side wall 42 has been fitted onto an outside of the partition wall 33 of the upper shell 12. As shown in FIG. 8, when the inner rotor 4 has been fitted onto the upper shell 12, the front ends of the protrusions 45 formed in the side wall 42 make line contact with the outer circumferential surface of the partition wall 33. This means that surface contact between the inner circumferential surface of the side wall 42 and the outer circumferential surface of the partition wall 33 is avoided, and therefore the inner rotor 4 can rotate smoothly. Also, in a state where the disc cartridge 1 is not loaded into a drive apparatus, that is, when the disc cartridge 1 is not in use, rotation of the inner rotor 4 with respect to the case main body 3 is restricted by a locking member 8 (see FIG. 1).

A mold for injection molding the inner rotor 4 is normally designed so that the direction in which the inner rotor 4 is released from the mold (i.e., the direction in which the inner rotor 4 is pressed out of the mold) is the same as the direction in which the side wall 42 is erected. Here, since the protrusions 45 of the inner rotor 4 are bar-shaped along the direction in which the side wall 42 is erected, unlike the conventional construction where textured surfaces are formed on the side wall, during injection molding, a situation where the side wall 42 causes resistance and makes it difficult to release the inner rotor 4 from the mold is avoided. Accordingly, with the inner rotor 4, unlike the conventional construction, it is possible to manufacture the inner rotor 4 efficiently without causing a decrease in manufacturing efficiency due to difficulty in releasing the inner rotor 4 from the mold.

As shown in FIG. 9, the shutter 5 includes a pair of shutter members 51a, 51b. Insertion holes 52 through which the convex portions 43 of the inner rotor 4 can pass are formed at one end of each of the shutter members 51a, 51b and the slits 53 through which the convex portions 24 of the lower shell 11 can pass are formed at the other ends of the shutter members 51a, 51b. As shown in FIG. 2, the shutter 5 is disposed inside the case main body 3 so as to be sandwiched between the base plate 22 (a base surface of the case main body 3) of the lower shell 11 and the base plate 41 of the inner rotor 4. When the disc cartridge 1 is loaded into a disc apparatus and the inner rotor 4 is rotated, the shutter members 51a, 51b of the shutter 5 rotate (move) around the insertion holes 52 together with such rotation to open and close an access path for accessing the optical disc 100 via the opening 3a of the case main body 3 and the opening 4a of the inner rotor 4. Note that in the following explanation, the opening and closing of the access path is also referred to as the “opening and closing (opening and covering) of the opening 3a and the opening 4a”.

Next, the method of using the disc cartridge 1 will be described with reference to the drawings.

As shown in FIG. 1, when the disc cartridge 1 has been ejected from a drive apparatus, that is, when the disc cartridge 1 is not in use, the opening 3a of the case main body 3 and the opening 4a of the inner rotor 4 are covered by the shutter members 51a, 51b of the shutter 5. On the other hand, when the disc cartridge 1 is loaded into a drive apparatus, the disc cartridge 1 is pulled by the drive apparatus into the drive apparatus in the direction of the arrow I. Note that although the lower shell 11 is shown facing upward in the drawings, during actual use, the disc cartridge 1 is loaded into the drive apparatus in a state where the upper shell 12 faces upward. When doing so, the inner rotor 4 is rotated by the shutter opening/closing means of the drive apparatus, and by doing so, the shutter members 51a, 51b of the shutter 5 are caused to rotate relatively with respect to the inner rotor 4 to open the openings 3a, 4a.

In more detail, first the shutter opening/closing means contacts the locking member 8 to cause the locking member 8 to slide relative to the case main body 3 so that rotation of the inner rotor 4 is permitted. Next, when the disc cartridge 1 has been pulled further inside the drive apparatus, the shutter opening/closing means engages engaging teeth 44 of the inner rotor 4, and by pulling the disc cartridge 1 further in in this state, the inner rotor 4 is caused to rotate with respect to the case main body 3 in the direction of the arrow B1 shown in FIG. 1. At this time, as the inner rotor 4 rotates, the shutter members 51a, 51b of the shutter 5 rotate (slide) about the insertion holes S2 (the convex portions 43 of the inner rotor 4). Next, by pulling the disc cartridge 1 further inside the drive apparatus, the opening 3a of the lower shell 11 and the opening 4a of the inner rotor 4 become aligned in the thickness direction of the disc cartridge 1, and then the shutter members 51a, 51b are rotated further and move away from a position above the opening 4a. As a result, the shutter members 51a, 51b that were closed when the disc cartridge 1 was not in use become completely open to expose the recording region of the optical disc 100, and by doing so, the access path for accessing the optical disc 100 from outside the case main body 3 via the openings 3a, 4a is produced.

As shown in FIG. 8, since the front ends of the protrusions 45 formed in the side wall 42 of the inner rotor 4 make line contact with the outer circumferential surface of the partition wall 33 of the upper shell 12 of the case main body 3, surface contact between the inner circumferential surface of the side wall 42 and the outer circumferential surface of the partition wall 33 is avoided and therefore the inner rotor 4 can rotate smoothly. As a result, the openings 3a, 4a can be smoothly opened by rotation of the shutter members 51a, 51b. After this, the chucking plate 7 is magnetically pulled by the drive apparatus to clamp a rim portion of a center hole 100a (see FIG. 3) or the optical disc 100, and irradiation with a laser beam (i.e., the recording or reproducing of data) is carried out via the opening 3a.

On the other hand, when the disc cartridge 1 for which the recording/reproducing of data has been completed is ejected from the drive apparatus, the inner rotor 4 is rotated in the direction of the arrow B2 shown in FIG. 1 by the shutter opening/closing means of the drive apparatus and the shutter members 51a, 51b of the shutter 5 rotate together with such rotation so that the openings 3a, 4a are covered by the shutter members 51a, 51b. Since the front ends of the protrusions 45 formed in the side wall 42 of the inner rotor 4 make line contact with an outer circumferential surface of the partition wall 33 in the upper shell 12 of the case main body 3, surface contact between the inner circumferential surface of the side wall 42 and the outer circumferential surface of the partition wall 33 is avoided and therefore the inner rotor 4 can rotate smoothly. As a result, the openings 3a, 4a can be smoothly covered by rotation of the shutter members 51a, 51b.

In this way, according to the cartridge case 2 and the disc cartridge 1, the inner rotor 4 is constructed with bar-shaped protrusions 45 formed on the inner circumferential surface of the side wall 42 along the direction in which the side wall 42 is erected, and therefore it is possible for the front ends of the protrusions 45 of the inner rotor 4 to make line contact with the outer circumferential surface of the partition wall 33 of the case main body 3. This means that surface contact between the inner circumferential surface of the side wall 42 and the outer circumferential surface of the partition wall 33 is reliably avoided and the inner rotor 4 can rotate smoothly. As a result, the openings 3a, 4a can be smoothly opened and closed by rotation of the shutter members 51a, 51b. Also, by forming the protrusions 45 in bar shapes along the direction in which the side wall 42 is erected, during injection molding of the inner rotor 4, it is possible to reliably avoid a situation where the protrusions 45 cause resistance when releasing the inner rotor 4 from the mold and therefore make it difficult to release the inner rotor 4. This means that unlike the conventional construction where the formation of a textured surface, for example, in the side wall makes it difficult to release the inner rotor 4 from a mold, there is no drop in manufacturing efficiency due to difficulty in releasing the inner rotor 4 from the mold, and therefore it is possible to manufacture the inner rotor 4 and in turn the cartridge case 2 and the disc cartridge 1 with sufficient efficiency.

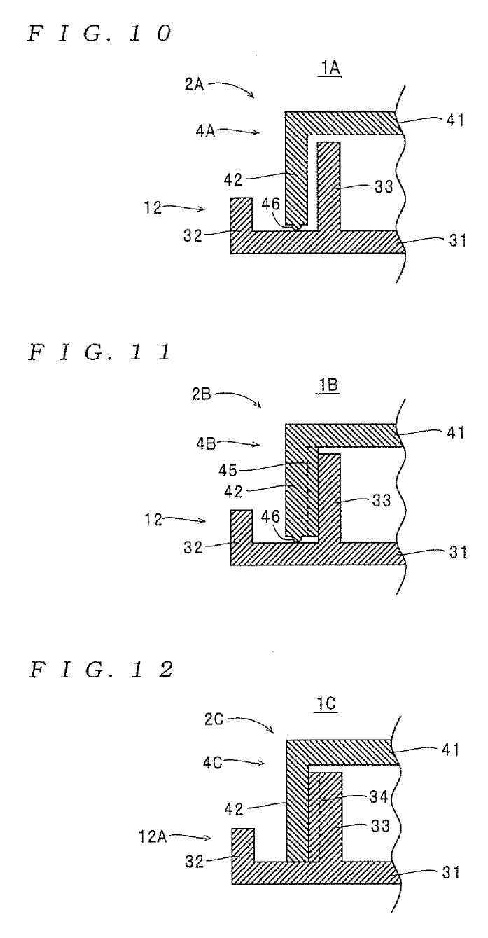

Note that the present invention is not limited to the construction described above. For example, although the inner rotor 4 equipped with the bar-shaped protrusions 45 formed in the inner circumferential surface of the side wall 42 along the direction in which the side wall 42 is erected has been described as an example, as shown in FIG. 10, it is possible to use an inner rotor 4A equipped with hemispherical protrusions 46 formed in a front end surface (the lower end surface in FIG. 10) of the side wall 42 in place of the protrusions 45. Note that in FIGS. 10 to 14 and the description below, construction elements that are the same as those described above have been assigned the same reference numerals and duplicated description thereof has been omitted. As shown in FIG. 10, the inner rotor 4A is formed so that the diameter of the side wall 42 is slightly larger than the diameter of the partition wall 33 of the upper shell 12, and therefore the inner rotor 4A is constructed so that the inner rotor 4A can be fitted onto the upper shell 19 with some degree of play. This means that surface contact between the inner circumferential surface of the side wall 42 and the outer circumferential surface of the partition wall 33 is reliably avoided, and the Front ends of the protrusions 46 can make point contact with the inside (the upper side in FIG. 10) of the top plate 31 of the upper shell 12. Accordingly, with a cartridge case 2A and a disc cartridge 1A equipped with the inner rotor 4A, the inner rotor 4A can rotate smoothly, and as a result it is possible for the openings 3a, 4a to be opened and closed smoothly by rotation of the shutter members 51a, 51b. By forming the protrusions 46 on the front end surface of the side wall 42, during injection molding of the inner rotor 4A, it is possible to reliably avoid a situation where the protrusions 46 cause resistance when the inner rotor 4A is released from the mold and make it difficult to release the inner rotor 4A. As a result, it is possible to manufacture the inner rotor 4A and in turn the cartridge case 2A and the disc cartridge 1A with sufficient efficiency without causing a decrease in manufacturing efficiency due to difficulty in releasing the inner rotor 4A from the mold.

As shown in FIG. 11, it is also possible to use an inner rotor 4B equipped with both the protrusions 45, 46 described above. In a cartridge case 2B and a disc cartridge 1B equipped with the inner rotor 4B, it is possible to have front ends of the protrusions 45 of the inner rotor 4B make line contact with the outer circumferential surface of the partition wall 33 of the upper shell 12 and to have the front ends of the protrusions 46 make point contact with the inner surface of the top plate 31 of the upper shell 12. Accordingly, with the cartridge case 2B and the disc cartridge 1B, the inner rotor 4B can be smoothly rotated, and as a result, the openings 3a, 4a can be smoothly opened and closed by rotation of the shutter members 51a, 51b. Also, by forming the protrusions 45 in bar shapes along the direction in which the side wall 42 is erected and also forming the protrusions 46 on the front end surface of the side wall 42, during injection molding of the inner rotor 4B, it is possible to reliably avoid a situation where the protrusions 45, 46 cause resistance when releasing the inner rotor 4B from the mold and make it difficult to release the inner rotor 4B. As a result, it is possible to manufacture the inner rotor 4B and in turn the cartridge case 2B and the disc cartridge 1B with sufficient efficiency without causing a decrease in manufacturing efficiency due to difficulty in releasing the inner rotor 4B from the mold.

As shown in FIG. 12, it is also possible to use an inner rotor 4C that is not equipped with the protrusions 45, 46 in place of the inner rotors 4, 4A, and 45 and to use an upper shell 12A equipped with bar-shaped protrusions 34 that are semicircular in cross-section and are formed in the outer circumferential surface of the partition wall 33 along the direction in which the partition wall 33 is erected in place of the upper shell 12. The protruding length of the protrusions 34 from the outer circumferential surface of the partition wall 33 to the front ends of the protrusions 34 is set equal to or slightly shorter than the difference between the radius of the inner circumferential surface of the side wall 42 of the inner rotor 4C and the radius of the outer circumferential surface of the partition wall 33. In a cartridge case 2C and a disc cartridge 1C equipped with the inner rotor 4C and the upper shell 12A, it is possible for the front ends of the protrusions 34 of the upper shell 12A to make line contact with the inner circumferential surface of the side wall 42 of the inner rotor 4C. Accordingly, with the cartridge case 2C and the disc cartridge 1C, the inner rotor 4C can rotate smoothly, and as a result it is possible for the openings 3a, 4a to be opened and closed smoothly by rotation of the shutter members 51a, 51b. By forming the protrusions 34 in bar shapes along the direction in which the partition wall 33 is erected, during injection molding of the upper shell 12A, it is possible to reliably avoid a situation where the protrusions 34 cause resistance when the upper shell 12A is released from the mold and make it difficult to release the upper shell 12A. As a result, it is possible to efficiently manufacture the upper shell 12A and in turn the cartridge case 2C and the disc cartridge 1C with sufficient efficiency without causing a decrease in manufacturing efficiency due to difficulty in releasing the upper shell 12A from the mold.

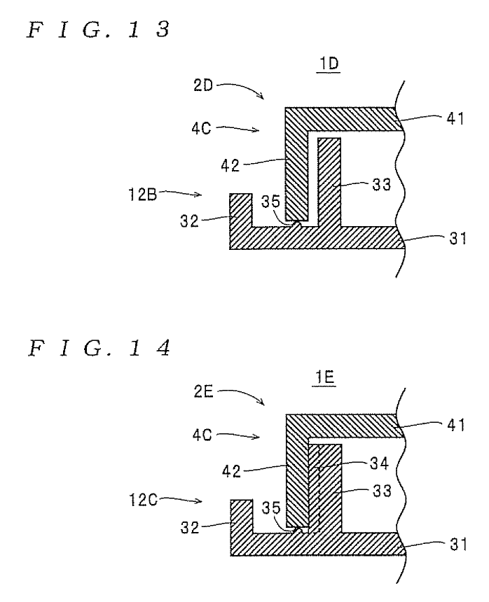

As shown in FIG. 13, together with the inner rotor 4C described above, it is possible to use an upper shell 12B equipped with hemispherical protrusions 35 formed at positions on the inner surface of the top plate 31 that face the front end surface of the side wall 42. Here, as shown in FIG. 13, the inner rotor 4C is formed so that the diameter of the side wall 42 is slightly larger than the diameter of the partition wall 33 of the upper shell 12B, and therefore is constructed so that the inner rotor 4C can be fitted onto the upper shell 12B with some degree of play. This means that with a cartridge case 2D and a disc cartridge 1D equipped with the inner rotor 4C and the upper shell 12B, surface contact between the inner circumferential surface of the side wall 42 of the inner rotor 4C and the outer circumferential surface of the partition wall 33 of the upper shell 12B can be reliably avoided, and the front ends of the protrusions 35 can make point contact with the front end surface of the side wall 42. Accordingly, with the cartridge case 2D and the disc cartridge 1D also, the inner rotor 4C can rotate smoothly, and therefore the openings 3a, 4a can be smoothly opened and closed by rotation of the shutter members 51a, 51b. Also, by forming the protrusions 35 on the inner surface of the top plate 31, during injection molding, it is possible to reliably avoid a situation where the protrusions 35 cause resistance when the upper shell 12B is released from the mold and make it difficult to release the upper shell 12B from the mold. Accordingly, it is possible to manufacture the upper shell 12B and in turn the cartridge case 2D and the disc cartridge 1D efficiently without causing a decrease in manufacturing efficiency due to difficulty in releasing the upper shell 12B from the mold.

As shown in FIG. 14, it is also possible to use the inner rotor 4C described above and an upper shell 12C equipped with both the protrusions 34, 35 described above. In a cartridge case 2E and a disc cartridge 1E equipped with the inner rotor 4C and the upper shell 12C, it is possible to have the front ends of the protrusions 34 of the upper shell 12C make line contact with the inner circumferential surface of the side wall 42 of the inner rotor 4C and to have the front ends of the protrusions 35 make point contact with the front end surface of the side wall 42. Accordingly, with the cartridge case 2E and the disc cartridge 1E also, the inner rotor 4C can rotate smoothly, and therefore the openings 3a, 4a can be smoothly opened and closed by rotation of the shutter members 51a, 51b. Also, by Lorming the protrusions 34 in bar shapes along the direction in which the partition wall 33 is erected and also forming the protrusions 35 on the inner surface of the top plate 31, during injection molding, it is possible to reliably avoid a situation where the protrusions 34, 35 cause resistance when the upper shell 12C is released from the mold and make it difficult to release the upper shell 12C from the mold. Accordingly, it is possible to manufacture the upper shell 12C and in turn the cartridge case 2E and the disc cartridge 1E with sufficient efficiency without causing a decrease in manufacturing efficiency due to difficulty in releasing the upper shell 12C from the mold.

It is also possible to use a construction where the inner rotor 4 equipped with the protrusions 45 and the upper shell 12B equipped with the protrusions 35 are combined and a construction where the inner rotor 4A equipped with the protrusions 46 and the upper shell 12A equipped with the protrusions 34 are combined, with the same effects as those described above being achieved by a cartridge case and a disc cartridge that use such constructions.

It is also possible to use an inner rotor where a textured surface (concave/convex surface) is formed on a front end surface of the side wall 42 in place of the protrusions 46. With this inner rotor, the presence of the textured surface makes it possible to reliably avoid surface contact between the front end surface of the side wall 42 and the inner surrace of the top plate 31 of the upper shell 12. In addition, it is possible to use an upper shell where a textured surface (concave/convex surface) is formed on an inner surface of the top plate 31 in place of the protrusions 35. With this upper shell also, the presence of the textured surface makes it possible to reliably avoid surface contact between the front end surface of the side wall 42 and the inner surface of the top plate 31 of the upper shell.

In addition, the expression “disc-shaped medium” for the present invention is not limited to the rewritable optical disc 100 described above, and includes not only various types of optical discs, such as a read-only optical disc and a write-once optical disc, but also magneto-optical discs and magnetic discs.

What is claimed is:

1. A cartridge case, comprising:
a case main body that has a partition wall, which is circular or arc-shaped in planar form and constructs an enclosure for rotatably enclosing a disc-shaped medium, erected on a top surface thereof and a first opening formed in a bottom surface thereof;
an inner rotor that has a circular-plate-shaped main portion in which a second opening is formed and a side wall erected along an outer circumferential edge of the main portion and is rotatably disposed inside the case main body in a state where the side wall is fitted onto an outside of the partition wall; and
a shutter that is disposed between the inner rotor and the bottom surface and moves as the inner rotor rotates, to open and close an access path for accessing the disc-shaped medium via the first and second openings,
wherein the inner rotor includes bar-shaped protrusions formed on an inner circumferential surface of the side wall along a direction in which the side wall is erected.

2. An information medium comprising:
a cartridge case according to claim 1; and
the disc-shaped medium enclosed inside the case main body of the cartridge case.

3. A cartridge case, comprising:
a case main body that has a partition wall, which is circular or arc-shaped in planar form and constructs an enclosure for rotatably enclosing a disc-shaped medium, erected on a top surface thereof and a first opening formed in a bottom surface thereof;
an inner rotor that has a circular-plate-shaped main portion in which a second opening is formed and a side wall erected along an outer circumferential edge of the main portion and is rotatably disposed inside the case main body in a state where the side wall is fitted onto an outside of the partition wall; and
a shutter that is disposed between the inner rotor and the bottom surface and moves as the inner rotor rotates, to open and close an access path for accessing the disc-shaped medium via the first and second openings,
wherein the inner rotor has protrusions formed on a front end surface of the side wall.

4. An information medium comprising:
a cartridge case according to claim 3; and
the disc-shaped medium enclosed inside the case main body of the cartridge case.

5. A cartridge case, comprising:
a case main body that has a partition wall, which is circular or arc-shaped in planar form and constructs an enclosure for rotatably enclosing a disc-shaped medium, erected on a top surface thereof and a first opening formed in a bottom surface thereof;
an inner rotor that has a circular-plate-shaped main portion in which a second opening is formed and a side wall erected along an outer circumferential edge of the main portion and is rotatably disposed inside the case main body in a state where the side wall is fitted onto an outside of the partition wall; and
a shutter that is disposed between the inner rotor and the bottom surface and moves as the inner rotor rotates, to open and close an access path for accessing the disc-shaped medium via the first and second openings,
wherein the case main body includes bar-shaped protrusions formed on an outer circumferential surface of the partition wall along a direction in which the partition wall is erected.

6. An information medium comprising:
a cartridge case according to claim 5; and
the disc-shaped medium enclosed inside the case main body of the cartridge case.

7. A cartridge case, comprising:
a case main body that has a partition wall, which is circular or arc-shaped in planar form and constructs an enclosure for rotatably enclosing a disc-shaped medium, erected on a top surface thereof and a first-opening formed in a bottom surface thereof;
an inner rotor that has a circular-plate-shaped main portion in which a second opening is formed and a side wall erected along an outer circumferential edge of the main portion and is rotatably disposed inside the case main body in a state where the side wall is fitted onto an outside of the partition wall; and
a shutter that is disposed between the inner rotor and the bottom surface and moves as the inner rotor rotates, to open and close an access path for accessing the disc-shaped medium via the first and second openings,
wherein the case main body has protrusions formed at positions on the top surface that face a front end surface of the side wall.

8. An information medium comprising:
a cartridge case according to claim 7; and
the disc-shaped medium enclosed inside the case main body of the cartridge case.
